(19) United States
(12) Patent Application Publication
(10) Pub. No.: US 2007/0179676 A1
(43) Pub. Date: Aug. 2, 2007

(54) Peak power-controlling apparatus and method

(76) Inventors: Takayuki Sasaki, Fukuoka (JP); Ryuji Fuchikami, Fukuoka (JP); Takashi Nishitoba, Kanagawa (JP); Toshihiro Ishikawa, Kanagawa (JP)

Correspondence Address: WENDEROTH, LIND & PONACK L.L.P., 2033 K. STREET, NW, SUITE 800, WASHINGTON, DC, 20006, US

(21) Appl. No.: 10/593,871

(22) PCT Filed: Nov. 25, 2005
(86) PCT No.: PCT/JP05/22143

§ 371 Date: Sep. 22, 2006

(30) Foreign Application Priority Data
Dec. 1, 2004 (JP) 2004-349032
Apr. 21, 2005 (JP) 2005-124121

(51) Int. Cl. G05D 11/00; G05B 15/02

(52) U.S. Cl. 700/295; 700/9

(57) ABSTRACT

A peak power-controlling apparatus including a generating unit (3) operable to generate at least one activating combination available within a predetermined period of time to activate a plurality of devices (6) to (8), each of which has an activating period and required electrical power, in which the activating period includes an operative period of time and an inoperative period of time, a calculating unit (4) operable to calculate a total power consumption value for each of the at least one activating combination, thereby providing the calculated total power consumption value, and a selecting unit (5) operable to select, as a selection result (12), one of the at least one activating combination based on the calculated total power consumption value. As a result, the peak power-controlling apparatus can suppress peak power of the plurality of devices that includes periodically operated devices.

### TECHNICAL FIELD

The present invention relates to a method for controlling the peak power of a periodically operated device-contained apparatus, and an art related thereto.

### BACKGROUND ART

In the past, an apparatus including a plurality of devices is designed to allow the plurality of devices to be activated at such adjusted periods of time as to maintain the devices within a permissible power value. For example, when the permissible power value is 10 watts, then one device having the power consumption value of 5 watts and another having the power consumption value of 7 watts are activated at such adjusted periods of time as to avoid operating them concurrently.

The device broadly includes processor-treatable programs as well as a circuit block or apparatus operable to execute a predetermined course of processing.

Cited Reference No. 1 (published Japanese Patent Application No. 2001-256064) discloses an example of adjusted activating timing as discussed above.

According to the cited Reference No. 1, assuming that there are provided first and second devices, each of which has an activating period of, e.g., 10 cycles, including an operative period of time or 5 cycles and an inoperative period of time or 5 cycles, they are operated at staggered periods of time, thereby providing reduced peak power.

At this time, when a third device having an operative period of time or 5 cycles is added to the first and second devices, each of the first and second devices are provided with an increased inoperative period of time or 10 cycles, and is thereby provided with an increased activating period or 15 cycles. As a result, there arises a 5-cycle period in which the first and second devices are both rendered inoperative, but the third device is allowed to run during the 5-cycle period. As a result, the peak power is suppressed to a level equal to or less than an electrical power value of each of the first to third devices.

Fewer devices result in a reduced activating period, but an increased activating period for more devices.

Thus, an increased or decreased activating period provides controlled peak power.

However, the prior art has a problem that the above system is inoperative when a device having an unchangeable activating period is included in the devices.

Furthermore, each of the plurality of devices must be authorized, through a complicated course of processing, to address a device-activating request when they are changed in number. In particular, according to the prior art, the devices are activated in a controlled manner on the premise that one of the devices is operated within each certain period of time, and consequently it is difficult to control concurrent operation of the plurality of devices. This causes another problem that both electrical power control and high-speed processing cannot be balanced with one another.

### DISCLOSURE OF THE INVENTION

In view of the above, an object of the present invention is to provide a peak power-controlling method and apparatus operable to activate a plurality of devices at adjusted periods, thereby providing controlled peak power.

A first aspect of the present invention provides a peak power-controlling method including the step of adjusting timing to activate periodically operated devices included in an apparatus, in such a manner that a total power consumption value reached by the periodically activated devices in operation is maintained within a predetermined value.

In electronic equipment having a plurality of devices operated therein, the above structure allows a value of electrical power consumed by the plurality of devices in action to be suppressed to a level equal to or less than a permissible power value. As a result, proper power consumption values are maintained.

A second aspect of the present invention provides a peak power-controlling method including the step of adjusting timing to activate the periodically operated devices so as to concurrently activate them when a total power consumption value reached by the periodically activated devices in operation is equal to or less than a predetermined value.

In electronic equipment having a plurality of devices operated therein, the above structure allows a value of electrical power consumed by the devices in action to be suppressed to a level equal to or less than the permissible power value. As a result, proper power consumption values are maintained.

A third aspect of the present invention provides a peak power-controlling method including the step of adjusting timing to activate periodically operated devices in order to minimize a total power consumption value reached by the periodically activated devices in operation.

In electronic equipment having the plurality of devices operated therein, the above structure allows a value of electrical power consumed by the devices in operation to be maintained to a minimum extent.

A fourth aspect of the present invention provides a peak power-controlling apparatus comprising, to control periodically operated devices, a unit operable to store device's attribute information, a unit operable to determine a power consumption value for each of the devices, a unit operable to compare the power consumption value for each of the devices with a permissible power value, a unit operable to determine device-activating timing to activate each of the devices, a unit operable to adjust the activation of each of the devices in accordance with the device-activating timing, and a unit operable to store a request for activating each of the devices.

In controlling a plurality of devices, the above structure allows a value of electrical power consumed by the devices in action to be suppressed to a level equal to or less than the permissible power value. As a result, proper power consumption values are maintained.

A fifth aspect of the present invention provides a peak power-controlling apparatus, further comprising a unit operable to determine variations in power consumption value.

In controlling a plurality of devices, the above structure allows a value of electrical power consumed by the devices in action to be suppressed to a level equal to or less than the permissible power value. As a result, proper power consumption values are maintained.

A sixth aspect of the present invention provides a peak power-controlling apparatus including a generating unit operable to generate at least one activating combination available within a predetermined period of time to activate a plurality of devices, each of which has an activating period and required electrical power, in which the activating period includes an operative period of time and an inoperative period of time, a calculating unit operable to calculate a total power consumption value for each of the at least one activating combination, thereby providing at least one calculated total power consumption value, and a selecting unit operable to select, as a selection result, one of the at least one activating combination based on the at least one calculated total power consumption value.

The above structure selects power consumption value-based optimum one of several device-activating combinations. As a result, proper power consumption values are maintained.

A seventh aspect of the present invention provides a peak power-controlling apparatus, in which the selecting unit selects, as the selection result, an activating combination having a minimum value among the at least one calculated total power consumption value.

The above structure selects an activating combination having a minimum power consumption value. As a result, the minimum power consumption value is maintained during any period of time.

An eighth aspect of the present invention provides a peak power-controlling apparatus, in which the predetermined period of time is substantially the same as the shortest one of the operative periods of time possessed by the plurality of devices.

The above structure allows one device to be activated in timing with another device that has just been deactivated. As a result, the power consumption value is maintained within the permissible power value, even when one device is overlapped with another in terms of an operative period of time.

A ninth aspect of the present invention provides a peak power-controlling apparatus, further including a reception unit operable to receive activating requests addressed by the plurality of devices, in which the generating unit generates the at least one activating combination available within the predetermined period of time to activate the plurality of devices that have addressed the activating requests.

The above structure makes it feasible to activate only the devices that have addressed the activating requests. As a result, the devices are efficiently activated without being wasted.

A tenth aspect of the present invention provides a peak power-controlling apparatus, further including a determining unit operable to determine, as a determination result, one of a plurality of activating combinations included in the selection result, when the selecting unit selects the plurality of activating combinations as the selection result.

The above structure determines the activating combination based on any reference other than the power consumption value.

An eleventh aspect of the present invention provides a peak power-controlling apparatus, in which the selecting unit compares a total power consumption value for each of the plurality of activating combinations with any permissible power value, thereby selecting, as the selection result, a plurality of activating combinations having total power consumption values equal to or smaller than the permissible power value.

The above structure provides an ultimately determined activating combination having a total power consumption value suppressed to a level equal to or less than the permissible power value.

A twelfth aspect of the present invention provides a peak power-controlling apparatus, in which the determining unit determines, as the determination result, one of the plurality of activating combinations included in the selection result, thereby providing a determined activating combination, in which the determined activation combination has the largest number of the devices to be activated.

The above structure determines an activating combination equal to or less than the permissible power value and having the greatest number of the devices to be activated. As a result, the activated devices have in total a power consumption value suppressed to a level equal to or less than the permissible power value, whereby the devices are operated at high speed.

A thirteenth aspect of the present invention provides a peak power-controlling apparatus, in which the determining unit determines, as the determination result, one of the plurality of activating combinations included in the selection result, thereby providing a determined activating combination, in which the determined activating combination has a maximum value among the at least one calculated total power consumption value.

The above structure allows the devices to be operated at the most efficient power consumption value.

A fourteenth aspect of the present invention provides a peak power-controlling apparatus, in which the determining unit determines, as the determination result, one of the plurality of activating combinations included in the selection result, thereby providing a determined activating combination, in which the determined activating combination has any one of the devices to have been activated the smallest number of times during a predetermined period of time.

The above structure uniformly activates a large number of devices.

A fifteenth aspect of the present invention provides a peak power-controlling apparatus, in which each of the plurality of devices has priority to be activated, and the determining unit calculates a total score of the priority for each of the plurality of activating combinations included in the selection result, thereby determining, as the determination result, an activating combination having maximum one of the total scores of the priority.

The above structure activates the devices in accordance with the device-activating priority. As a result, the devices are activated in light of the operational specification of the devices.

A sixteenth aspect of the present invention provides a peak power-controlling method including the step of generating at least one activating combination available within a predetermined period of time to activate a plurality of devices, each of which has an activating period and required electrical power, in which the activating period includes an operative period of time and an inoperative period of time, the step of calculating a total power consumption value for each of the at least one activating combination, thereby providing at least one calculated total power consumption value, and the step of selecting, as a selection result, one of the at least one activating combination based on the at least one calculated total power consumption value.

The above structure selects power consumption value-based optimum one of several device-activating combinations. As a result, appropriate power consumption values are maintained.

A seventeenth aspect of the present invention provides a peak power-controlling method, in which the step of selecting, as the selection result, one of the at least one activating combination based on the at least one calculated total power consumption value includes the step of selecting, as the selection result, an activating combination having a minimum value among the at least one calculated total power consumption value.

The above structure selects an activating combination having a minimum power consumption value. As a result, the minimum power consumption value is maintained during any period of time.

An eighteenth aspect of the present invention provides a peak power-controlling method, further including the step of receiving activating requests addressed by the plurality of devices, in which the step of generating the at least one activating combination available within the predetermined period of time to activate the plurality of devices includes the step of generating the at least one activating combination available within the predetermined period of time to activate the plurality of devices that have addressed the activating requests.

The above structure makes it feasible to activate only the devices that have addressed the activating requests. As a result, the devices are efficiently activated without being wasted.

A nineteenth aspect of the present invention provides a peak power-controlling method, further including the step of determining, as a determination result, one of a plurality of activating combinations included in the selection result, when the step of selecting, as the selection result, one of the at least one activating combination based on the at least one calculated total power consumption value includes the step of comparing a total power consumption value for each of the at least one activating combination with a predetermined permissible power value, to select, as the selection result, the plurality of activating combinations having total power consumption values equal to or smaller than the predetermined permissible power value.

The above structure determines the activating combination based on any reference other than the power consumption value.

A twentieth aspect of the present invention provides a peak power-controlling method, in which the step of determining, as the determination result, one of the plurality of activating combinations included in the selection result includes the step of determining, as the determination result, one of the plurality of activating combinations included in the selection result, thereby providing a determined activating combination, in which the determined activating combination is an selection from one of the following: the determined activating combination having the largest number of the devices to be activated; the determined activating combination having the maximum total power consumption value; and the determined activating combination having any one of the devices to have been activated the smallest number of times during a predetermined period of time.

The above structure activates the devices in accordance with the specification of the devices without allowing the power consumption value to exceed the permissible power value.

A twenty-first aspect of the present invention provides a peak power-controlling method, in which each of the plurality of devices has priority to be activated, and the step of determining, as the determination result, one of the plurality of activating combinations included in the selection result includes the step of calculating a total score of the priority for each of the plurality of activating combinations included in the selection result, thereby determining, as the determination result, an activating combination having maximum one of the total scores of the priority.

The above structure activates the devices in accordance with the device-activating priority. As a result, the devices are activated in light of the operational specification of the devices.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating a peak power-controlling apparatus according to a first embodiment of the present invention;

FIG. 2 is a flowchart illustrating a process for adjusting device-activating time according to the first embodiment;

FIG. 3 is a flowchart illustrating another process for adjusting device-activating time according to the first embodiment upon the receipt of a signal indicative of the completion of a device-related course of action;

FIG. 4 is an illustration showing a relationship between an operative period of time for each device, and a power consumption value according to the first embodiment;

FIG. 5 is a block diagram illustrating a peak power-controlling apparatus according to a second embodiment;

FIG. 6 is a flowchart illustrating a process of adjusting device-activating time according to the second embodiment;

FIG. 7 is a flowchart illustrating a process of adjusting device-activating time according to the second embodiment upon the receipt of a signal indicative of the completion of a device-related course of action;

FIG. 8 is an illustration showing a relationship between an operative period of time for each device and a power consumption value according to the second embodiment;

FIG. 9 is a block diagram illustrating a peak power-controlling apparatus according to a third embodiment;

FIG. 10 is a block diagram illustrating another peak power-controlling apparatus according to the third embodiment;

FIG. 11 is a block diagram illustrating a further peak power-controlling apparatus according to the third embodiment;

FIG. 12 is a chart illustrating one pattern of timing to activate each device according to the third embodiment; and

FIG. 13 is a chart illustrating another pattern of timing to activate devices according to the third embodiment.

### BEST MODE FOR CARRYING OUT THE INVENTION

Embodiments of the present invention are now described with reference to the accompanying drawings.

### First Embodiment

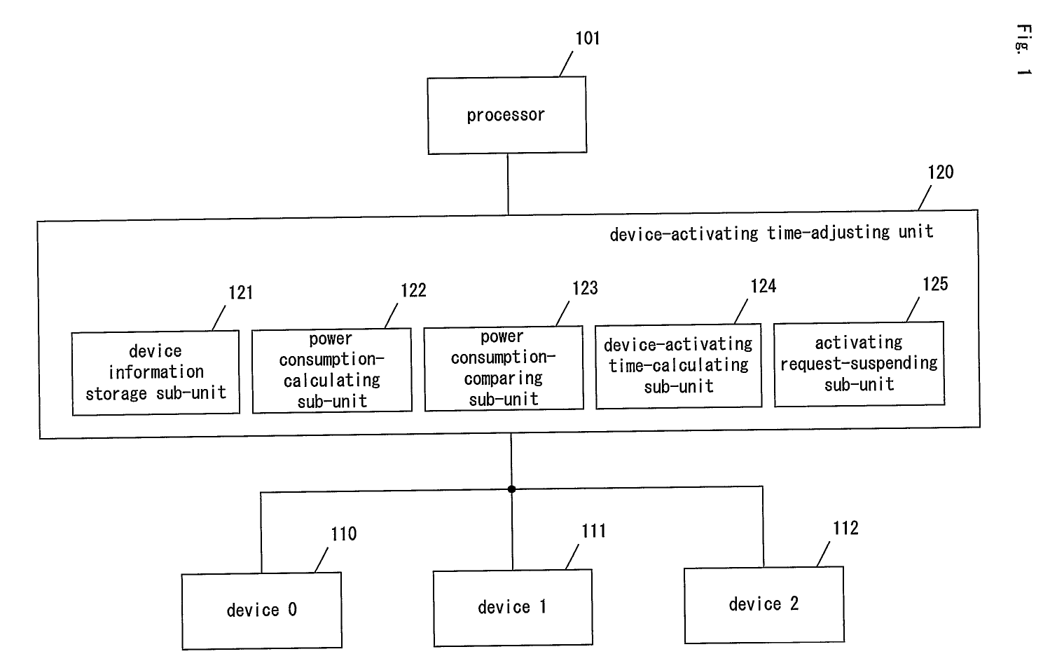

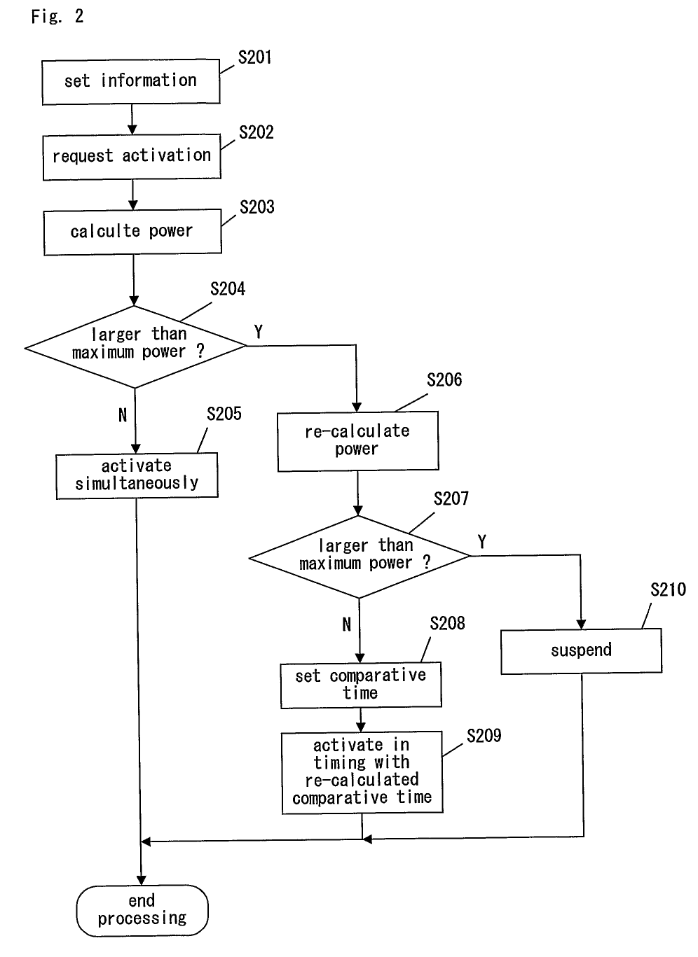

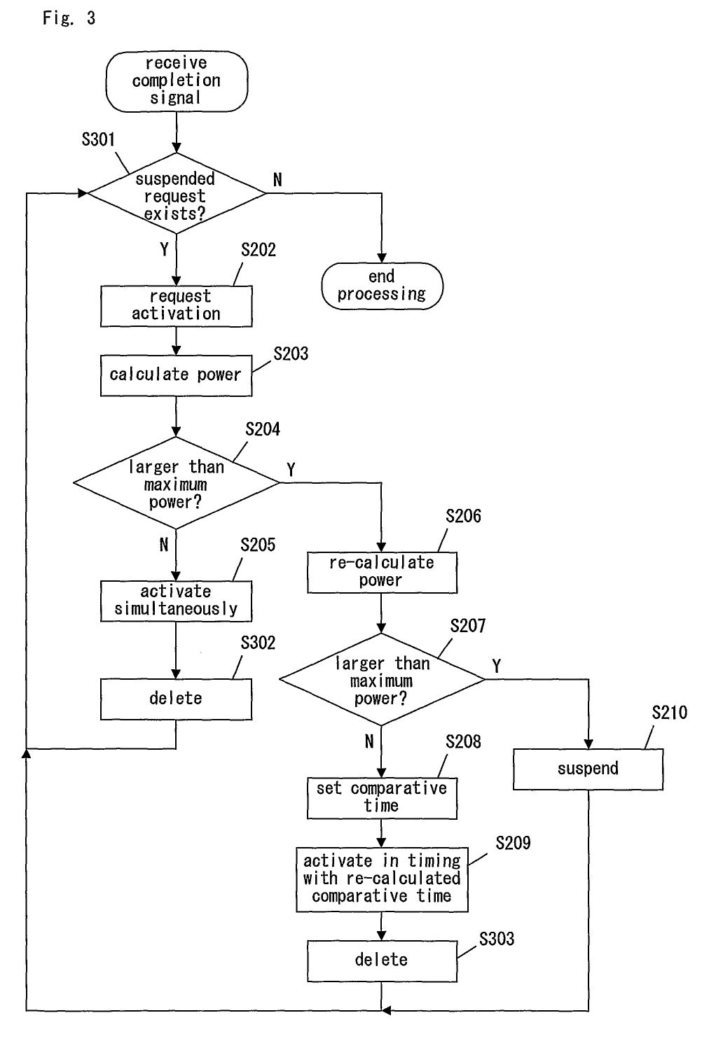

FIG. 1 is a block diagram illustrating a peak power-controlling apparatus according to a first embodiment of the present invention. FIG. 2 is a flowchart illustrating a process for adjusting device-activating time according to the present embodiment. FIG. 3 is a flowchart illustrating another process for adjusting device-activating time according to the present embodiment upon the receipt of a signal indicative of the completion of a device-related course of action.

The following discusses, with reference to FIG. 1, the construction of the peak power-controlling apparatus according to the present embodiment.

The peak power-controlling apparatus includes a processor 101, a device-activating time-adjusting unit 120, and devices 110, 111, and 112. The devices 110, 111, and 112 are periodically operated after being at first activated. The processor is not limited to a single unit, but several processors may be provided. Alternatively, the processor may be replaced by a sequencer operable to activate the devices. Each of the devices broadly includes a DMA, a vector arithmetic unit, a communication apparatus, or otherwise a processor itself, and a processor-controllable circuit or program. The present embodiment calls them “devices” in accordance with usual practice. Although the present embodiment exemplifies the three different devices, the devices must be at least two units, but may be greater or smaller in quantity. A non-periodically activated device may optionally be included.

The processor 101 possesses a channel designed to transmit a signal indicative of a device-activating request through the device-activating time-adjusting unit 120.

The device-activating time-adjusting unit 120 includes elements as discussed below. A device information storage sub-unit 121 is operable to store device's attribute information such as a power consumption value, an activating period, and an operative period of time for each of the devices 110, 111, and 112. A power consumption-calculating sub-unit 122 is operable to calculate a current power consumption value. A power consumption-comparing sub-unit 123 is operable to compare the current power consumption value with a permissible power consumption value. A device-activating time-calculating sub-unit 124 is operable to calculate device-activating time on the basis of both a result from the comparison as made by the power consumption-comparing sub-unit 123, and the stored information from the device information storage sub-unit 121. An activating request-suspending sub-unit 125 is operable to suspend the device-activating request sent from the processor 101.

The device-activating time-adjusting unit 120 adjusts the device-activating time in accordance with a current status in which electrical power is consumed. The device-activating time-adjusting unit 120 may be constructed by either hardware or software, or otherwise by both of the hardware and the software.

The following discusses a flow of processing according to a peak power-controlling method with reference to FIGS. 2 and 3.

At step S201, the device's attribute information is stored in the device information storage sub-unit 121. At step S202, the processor 101 sends out a signal indicative of the device-activating request to the device-activating time-adjusting unit 120.

At step S203, the power consumption-calculating sub-unit 122 calculates a total power consumption value that is reached when a target device requested to be activated is activated at a certain period of time (hereinafter called “comparative time”).

At step S204, the power consumption-comparing sub-unit 123 compares the calculated power consumption value from the power consumption-calculating sub-unit 122 with a permissible power consumption value.

When the calculated power consumption value is equal to or smaller than the permissible power consumption value, then at step S205, the device requested to be activated is activated at the comparative time by means of the device-activating time-adjusting unit 120. Conversely, when the calculated power consumption value is greater than the permissible power consumption value, then at step S206, the device-activating time-calculating sub-unit 124 adds, to the comparative time, a period of time in which the device in action is operated, thereby providing new comparative time; thereafter the device-activating time-calculating sub-unit 124 re-calculates a total power consumption value that is reached when the device is operated at the new comparative time.

At step S207, the power consumption-comparing sub-unit 123 determines whether the re-calculated power consumption value is greater than the permissible power consumption value of the peak power-controlling apparatus.

The determination in step S207 results in “NO”, then at step S208, the device-activating time-calculating sub-unit 124 establishes the new comparative time calculated in step S206. At step S209, the device requested to be activated is activated in timing with the new comparative time.

Conversely, the determination in step S207 results in “YES”, then at step S210, the activating request-suspending sub-unit 125 suspends the device-activating request.

The device-activating time-adjusting unit 120 permits the new comparative time to be stored as device-activating time in the device information storage sub-unit 121.

Another course of action as illustrated in FIG. 3 is executed when the device-activating time-adjusting unit 120 receives a notification of the completion of the previous device-related course of action.

At step S301, the device-activating time-adjusting unit 120 checks for the device-activating request suspended in the activating request-suspending sub-unit 125.

When the device-activating request is present, then at step S203, the power consumption-calculating sub-unit 122 calculates a total power consumption value that is reached when the device requested to be activated is activated at the comparative time.

At step S204, the power consumption-comparing sub-unit 123 determines whether the calculated power consumption value is greater than the permissible power consumption value.

When the determination in step S204 results in “NO”, then at step S205 a suspended device is activated in timing with the comparative time.

Conversely, when the determination in step S204 results in “YES”, at step S206 the device-activating time-calculating sub-unit 124 re-calculates a total power consumption value that is reached when the device is activated at new comparative time. The new comparative time is an addition of the previous comparative time and a period of time in which the device in action is operated.

When the determination in the next step S207 results in that the re-calculated power consumption value is smaller than the permissible power value, then at step S208, the power consumption-comparing sub-unit 123 stores the calculated new comparative time from the device-activating time-calculating sub-unit 124. At step S209, the suspended device is activated in timing with the new comparative time.

Conversely, when the determination in step S207 results in the contrary, the device-activating time-adjusting unit 120 allows the new comparative time to be stored as device-activating time in the device information storage sub-unit 121.

At either step S302 or step S303 after the execution of the processing in either step S205 or step S209, the device-activating time-adjusting unit 120 deletes the device-activating request for the already activated device from the activating request-suspending sub-unit 125.

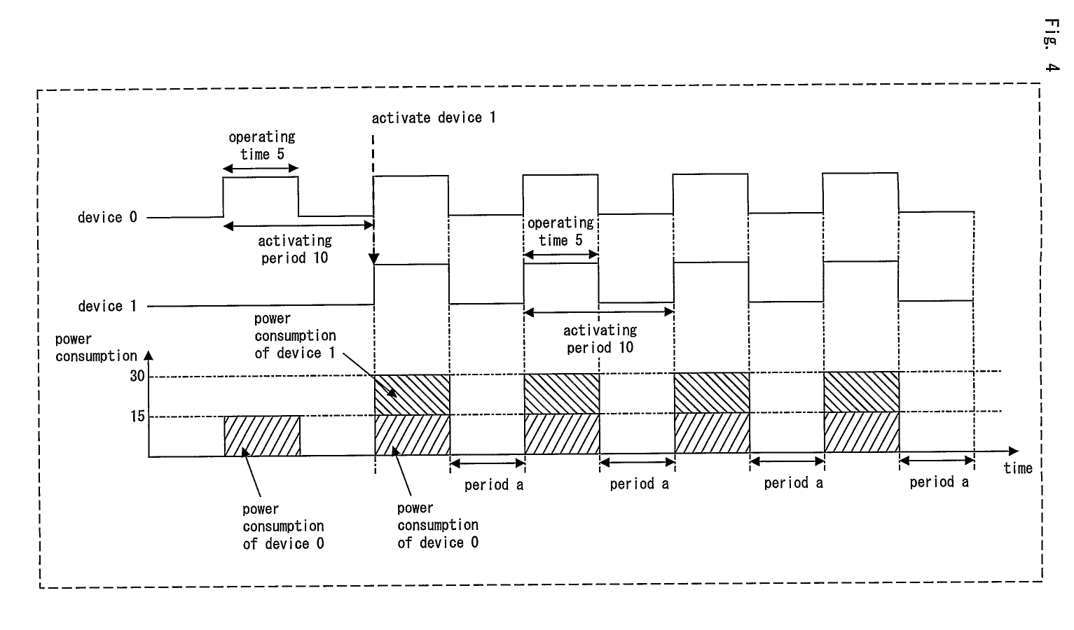

The following specifically discusses, with reference to FIG. 4, a course of action provided by the device-activating time-adjusting unit 120.

For example, devices 0 and 1 are periodically operated. The device 0 has been in operation, and an adjustment is made to a period of time in which the device 1 is activated.

Initially, the processor 101 establishes, as device's attribute information, an activating period 10, an operating period 5, and a power consumption value 15 for each of the devices 0 and 1.

Thereafter, the processor 101 addresses a request for activating the device 1. The power consumption-calculating sub-unit 122 calculates a total power consumption value that is reached when the device 1 is activated at the comparative time. The calculated power consumption value is the value “30”. As illustrated in FIG. 4, when the permissible electrical power value is the value “30”, the calculated power consumption value remains within the permissible electrical power value, even when both of the devices 0 and 1 are operated. Accordingly, the devices 1 and 0 are concurrently activated.

At this time, there arises a time period “a” at which both of the devices 0 and 1 remain at rest. Accordingly, any device having the maximum power consumption value “30” is operable at the time period “a”.

The device's attribute information broadly includes power consumption value-correlated information such as a clock frequency and an electrical current value as well as the power consumption value.

The peak power-controlling apparatus may have the processor and peripheral devices thereof integrated into a LSI (a single system), or otherwise may have them individually combined together.

### Second Embodiment

A second embodiment is now described.

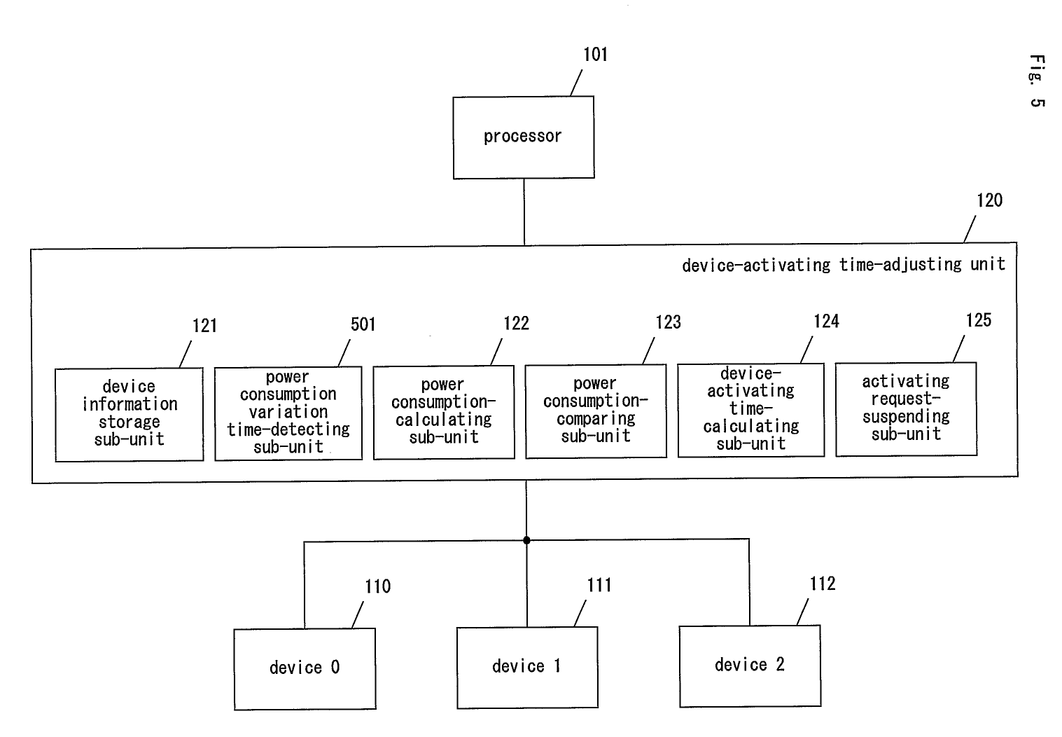

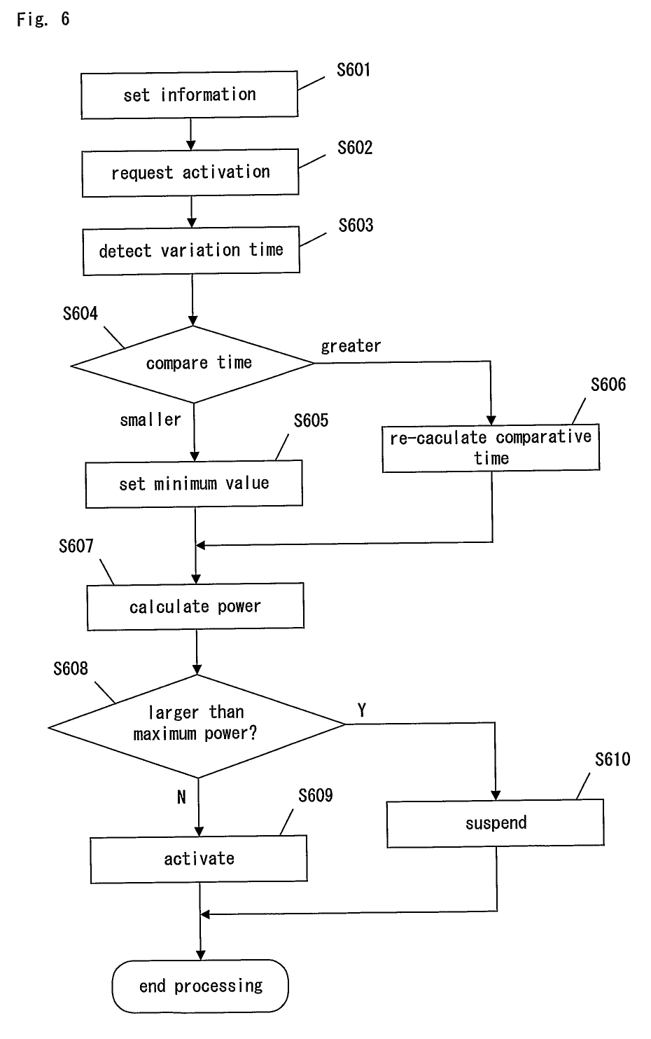

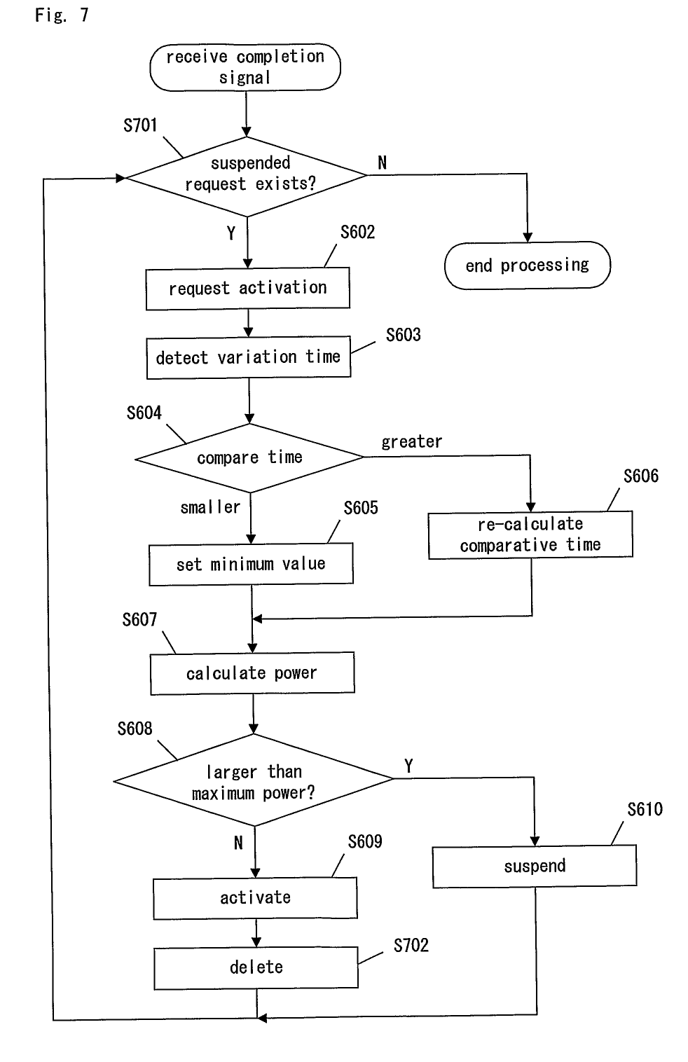

FIG. 5 is a block diagram illustrating a peak power-controlling apparatus according to the present embodiment. FIG. 6 is a flowchart illustrating a process for adjusting device-activating time according to the present embodiment. FIG. 7 is a flowchart illustrating another process for adjusting device-activating time according to the present embodiment upon the receipt of a signal indicative of the completion of a device-related course of action.

The peak power-controlling apparatus of FIG. 5 is similar to that of FIG. 1, except for the presence of a power consumption variation time-detecting sub-unit 501.

The power consumption variation time-detecting sub-unit 501 is operable to determine respective periods of time in which maximum and minimum power consumption values are reached by each device in action, and a period of time in which the minimum power consumption value is terminated.

The following discusses, with reference to FIGS. 6 and 7, a flow of processing in the peak power-controlling apparatus that includes the power consumption variation time-detecting sub-unit 501.

At step S601, device's attribute information is stored in the device information storage sub-unit 121. At step S602, the processor 101 sends out a signal indicative of a device-activating request to the device-activating time-adjusting unit 120.

At step S603, the power consumption variation time-detecting sub-unit 501 determines respective periods of time in which minimum and maximum power consumption values are reached by each device in action, and a period of time in which the minimum power consumption value is terminated.

At step S604, the device-activating time-calculating sub-unit 124 compares a difference in time between the respective periods of time where the minimum and maximum power consumption values are provided, with a period of time in which a device requested to be activated is operated.

When the period of time in which the device requested to be activated is operated is equal to or smaller than the time difference, then at step S605, the period of time in which the minimum power consumption value is provided is stored as comparative time.

Conversely, when the period of time in which the device requested to be activated is operated is greater than the time difference, then at step S606, the period of time in which the device requested to be activated is operated is subtracted from the period of time in which the minimum power consumption value is terminated, whereby the resulting period of time is stored as new comparative time.

At step S607, the power consumption-calculating sub-unit 122 calculates a total power consumption value that is reached when the device requested to be activated is activated at the comparative time.

At step S608, the power consumption-comparing sub-unit 123 determines whether the calculated power consumption value is greater than a permissible power value of the peak power-controlling apparatus.

When the determination in step S608 results in “NO”, then at step S609 the device is activated at the comparative time.

Conversely, when the determination in step S608 results in “YES”, then at step S610 the device-activating request is saved in the activating request-suspending sub-unit 125. The device-activating time-adjusting unit 120 allows the comparative time to be stored as device-activating time into the device information storage sub-unit 121.

The processing of checking for the suspended device-activating requests as illustrated in FIG. 7 is added to the flow of processing of FIG. 6 when the device-activating time-adjusting unit 120 receives a notification of the completion of the device-related course of action.

Upon the receipt of the notification as just discussed previously, then at step S701, the device-activating time-adjusting unit 120 checks for the device-activating request suspended in the activating request-suspending sub-unit 125.

When it is found as a result of step S701 that the suspended device-activating request is present, then at step S603, the power consumption variation time-detecting sub-unit 501 determines respective periods of time in which minimum and maximum power consumption values are reached by the device in action, and a period of time in which the minimum power consumption value is terminated.

At step S604, the device-activating time-calculating sub-unit 124 compares a time period between the respective periods of time in which the minimum and maximum power consumption values are provided, as determined in step S603, with a period of time in which a device concerned with the suspended device-activating request is operated.

When the comparison in step S604 shows that the period of time in which the device concerned with the suspended device-activating request is operated is smaller than the time period between the respective periods of time in which the minimum and maximum power consumption values are provided, then at step S605, the period of time in which the minimum power consumption value is provided is stored as comparative time.

Conversely, when the comparison in step S604 results in the contrary, then at step S606, the period of time in which the device concerned with the suspended device-activating request is operated is subtracted from the period of time in which the minimum power consumption value is provided, whereby the resulting time is stored as new comparative time.

At step S607, the power consumption-calculating sub-unit 122 calculates a total power consumption value that is reached when the device requested to be activated is activated at the comparative time.

At step S608, the power consumption-comparing sub-unit 123 determines whether the calculated power consumption value is greater than the permissible power value of the peak power-controlling apparatus.

When the determination in step S608 results in “NO”, then at step S609 the device is activated at the comparative time.

Conversely, when the determination in step S608 results in “YES”, the device information storage sub-unit 121 stores the comparative time as device-activating time.

At step S702, the device-activating time-adjusting unit 120 deletes the device-activating request for the activated device from the activating request-suspending sub-unit 125.

After the execution of the processing in either step S702 or step S608, the processing in step S701 is re-executed.

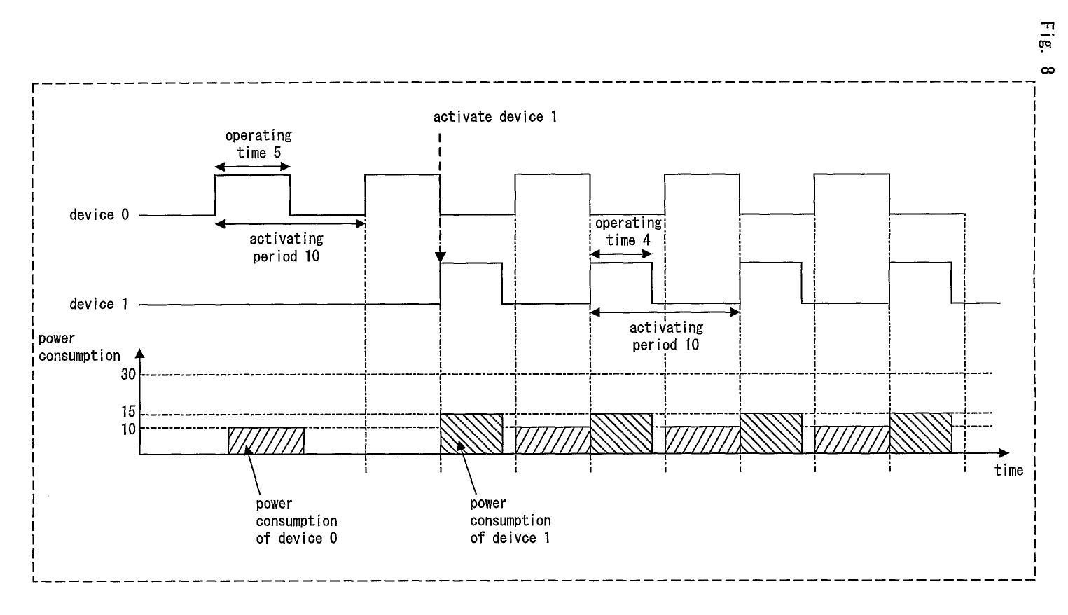

The following discusses, with reference to FIG. 8, a course of action provided by the activation time-adjusting unit 120.

For example, devices 0 and 1 are periodically operated. The device 0 has already been in operation, and a request for activating the device 1 has been addressed.

Initially, the processor 101 stores attribute information on the device 0 in the device information storage sub-unit 121. The attribute information includes an activating period having the value “10”, an operative period of time having the value “5”, and the power consumption value “10”. Similarly, the processor 101 stores attribute information on the device 1 in the device information storage sub-unit 121. The attribute information on the device 1 includes an activating period having the value “10”, an operative period of time having the value “4”, and the power consumption value “15”.

Thereafter, the processor 101 addresses a request for activating the device 1. The power consumption variation time-detecting sub-unit 501 detects, on the basis of the period of time in which the device 0 in action is operated, time period “5” at which the power consumption value is minimized, and time period “10” at which the power consumption value is maximized.

The device-activating time-calculating sub-unit 124 compares the time period “5” between the minimized power consumption value and the maximized power consumption value with the time period “4” in which the device 1 is operated. The time period “4” is smaller than the time period “5”, and the device-activating time-calculating sub-unit 124 sets up the value “5” as comparative time.

According to the power consumption-calculating sub-unit 122, a total power consumption value at comparative time “5” is the value “15” reached by only the device 1. When the peak power-controlling apparatus has the permissible power value “30”, the total power consumption value “15” is smaller than the permissible power value, and the device 1 is activated at comparative time “5”.

Owing to the method and construction as described above, the peak power-controlling apparatus including the periodically activated devices provides controlled peak power, and in addition suppresses excessive heating from the devices.

The device's attribute information is not limited to the power consumption values, but broadly includes power consumption value-correlated information such as a clock frequency and an electrical current value.

The peak power-controlling apparatus may have the processor and peripheral devices thereof integrated into a LSI (a single system), or otherwise may have them individually combined together.

### Third Embodiment

A third embodiment is now described. A peak power-controlling apparatus and method according to the present embodiment is operable to adjust the activation of a plurality of devices within a predetermined period of time.

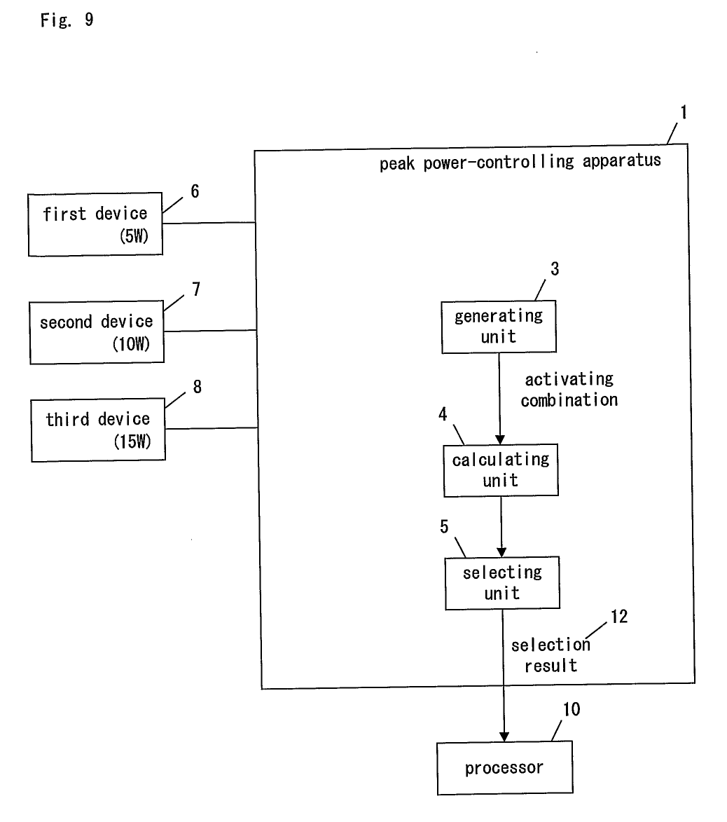

FIG. 9 is a block diagram illustrating the peak power-controlling apparatus according to the present embodiment.

Each of first, second, and third devices 6, 7, and 8 has an activating period that includes operative and inoperative periods of time. For example, the first device 6 has an activating period of 10 cycles (cycle as any time unit), which includes 5 cycles as an operative period of time and 5 cycles as an inoperative period of time. The second device 7 has an activating period of 20 cycles that includes 10 cycles as an operative period of time and 10 cycles as an inoperative period of time.

Each of the devices has any variable operative and inoperative periods of time. Alternatively, each of the devices may have a fixed operative period of time and a variable inoperative period of time.

For convenience of description, the present embodiment is premised on that the first, second, and third devices 6, 7, and 8 have operative periods of time or 5 cycles, 10 cycles, and 15 cycles, respectively, while each of the devices has a control-changeable inoperative period of time.

Each of the devices has information on required electrical power as required to operate each of them. For convenience of description, the present embodiment is premised on that the first, second, and third devices 6, 7, and 8 have different levels of required power or 5 W (“W” short for watt), 10 W, and 15 W, respectively. The term “W” as given hereinafter is also provided in the accompanying drawings as well as the Tables herein contained.

Each of the devices broadly includes processor-treatable programs as well as a circuit block and apparatus operable to execute a predetermined course of processing.

The following discusses the construction of the peak power-controlling apparatus 1 and a course of operation provided thereby, on the premise that the peak power-controlling apparatus 1 includes the above three different devices.

The peak power-controlling apparatus 1 is operable to activate each of the three different devices (the first to third devices 6, 7, and 8) in a controlled manner within a predetermined period of time, thereby providing controlled peak power of the three devices. At this time, the peak power-controlling apparatus 1 may activate and control the devices at either only a predetermined period of time or several predetermined periods of time. Alternatively, the peak power-controlling apparatus 1 may activate and control the devices either over predetermined successive periods of time or at each of several discrete or periodical predetermined periods of time.

The peak power-controlling apparatus 1 includes elements as discussed below.

To activate a plurality of devices (the first to third devices 6, 7, and 8 according to the present embodiment), each of which has an activating period including operative and inoperative periods of time, and required power-related information, a generating unit 3 is operable to generate at least one activating combination available at a predetermined period of time. The generating unit 3 feeds the generated activating combination into a calculating unit 4.

It is preferred that the predetermined period of time is substantially the same as the shortest one of the operative periods of the first, second, and third devices 6, 7, and 8. Pursuant to the present embodiment, the first device has the shortest operative period of time or 5 cycles, and therefore the predetermined period of time is 5 cycles. The generating unit 3 generates, as an activating combination, a combination of the devices to be activated at the time period of 5 cycles.

The generating unit 3 generates all of the activating combinations in which the devices to be activated can be combined with each other. For example, referring to Table 1, a list of activating combinations is shown prepared.

TABLE 1

| | activating combination |
|---|---|
| 1 | first device |
| 2 | second device |
| 3 | third device |
| 4 | first device + second device |
| 5 | first device + third device |
| 6 | second device + third device |
| 7 | first device + second device + third device |

As evidenced by Table 1, Activating Combination No. 1 activates only the first device 6 within a predetermined period of time; Activating Combination No. 2 activates only the second device 7 within a predetermined period of time; Activating Combination No. 3 activates only the third device 8 within a predetermined period of time; Activating Combination No. 4 activates the first and second devices 6 and 7 within a predetermined period of time; Activating Combination No. 5 activates the first and third devices 6 and 8 within a predetermined period of time; Activating Combination No. 6 activates the second and third devices 7 and 8 within a predetermined period of time; and, Activating Combination No. 7 activates all of the first, second, and third devices 6, 7, and 8 within a predetermined period of time.

Although the list of activating combinations as illustrated in Table 1 contains all of the device-activating combinations, an alternative list of activating combinations may be provided, which excludes a combination of devices having operative periods of time disallowed to overlap with each other. For example, assuming that an overlap is prohibited between the operative periods of time possessed by both of the first and second devices, a list of activating combinations free of Activating Combinations No. 4 and No. 7 of Table 1 is prepared.

The calculating unit 4 calculates a total power consumption value for each activating combination. Each of the first, second, and third devices 6, 7, and 8 has a piece of required power-related information, and the calculating unit 4 calculates a total power consumption value for each of the activating combinations in accordance with the required power-related information. The results from the calculation are illustrated in Table 2.

As evidenced by Table 2, the total power consumption value is 5 W for Activating Combination No. 1; 10 W for Activating Combination No. 2; 15 W for Activating Combination No. 3; 15 W for Activating Combination No. 4; 20 W for Activating Combination No. 5; 25 W for Activating Combination No. 6; and 30 W for Activating Combination No. 7.

The calculating unit 4 feeds the results of the calculated total power consumption values into a selecting unit 5.

TABLE 2

| | | total power |
|---|---|---|
| | activating combination | consumption |
| 1 | first device | 5 W |
| 2 | second device | 10 W |
| 3 | third device | 15 W |
| 4 | first device + second device | 15 W |
| 5 | first device + third device | 20 W |
| 6 | second device + third device | 25 W |
| 7 | first device + second device + third device | 30 W |

The selecting unit 5 compares a total power consumption value for each of the activating combinations of Table 2 with a predetermined value. The predetermined value may be a predetermined permissible power value. The permissible power value may be determined based on either the capacity of a loaded battery or a heat-defined power consumption value. In short, the permissible power value is determined in various manners, depending upon the specification of the peak power-controlling apparatus 1.

The permissible power value may optionally be varied with a temporal change. For example, assuming that processing to determine the activating combination is repeated several times, a different permissible power value may be applied each time when the processing is made.

The selecting unit 5 selects one of the activating combinations as a selection result 12 on the basis of the results from the comparison, and the selection result 12 is fed out of the selecting unit 5. More specifically, an activating combination that fulfills a predetermined specification is selected as the selection result 12, by means of the selecting unit 5, from among at least one activating combination or the seven different activating combinations according to the present embodiment.

For example, the selecting unit 5 selects, as the selection result 12, an activating combination having a minimum total power consumption value. As evidenced by Table 2, the present embodiment selects Activating Combination No. 1 that activates only the first device.

Alternatively, the selecting unit 5 selects, as the selection result 12, an activating combination in which the greatest number of the devices are activated. As evidenced by Table 2, the present embodiment selects Activating Combination No. 7.

As a further alternative, the selecting unit 5 selects, as the selection result 12, an activating combination equal to or smaller than the permissible power value and having a maximum total power consumption value. As evidenced by Table 2, Activating Combination No. 5 is selected when the permissible power value is 20 W, but Activating Combination No. 7 is selected for the permissible power value of 30 W.

As a yet further alternative, the selecting unit 5 selects, as the selection result 12, an activating combination equal to or smaller than the permissible power value and having the greatest number of the devices activated. For example, when the permissible power value is 15 W, the activating combination equal to or smaller than the permissible power value includes four different combinations or rather Activating Combinations No. 1 to No. 4, from among which Activating Combination No. 4 is selected, which activates two different devices or the first and second devices 6 and 7.

The selection result 12 is sent out to a processor 10. The processor 10 in receipt of the selection result 12 activates the devices. Alternatively, the selection result 12 may be sent out directly to the devices, so that the devices in receipt thereof are self-activated.

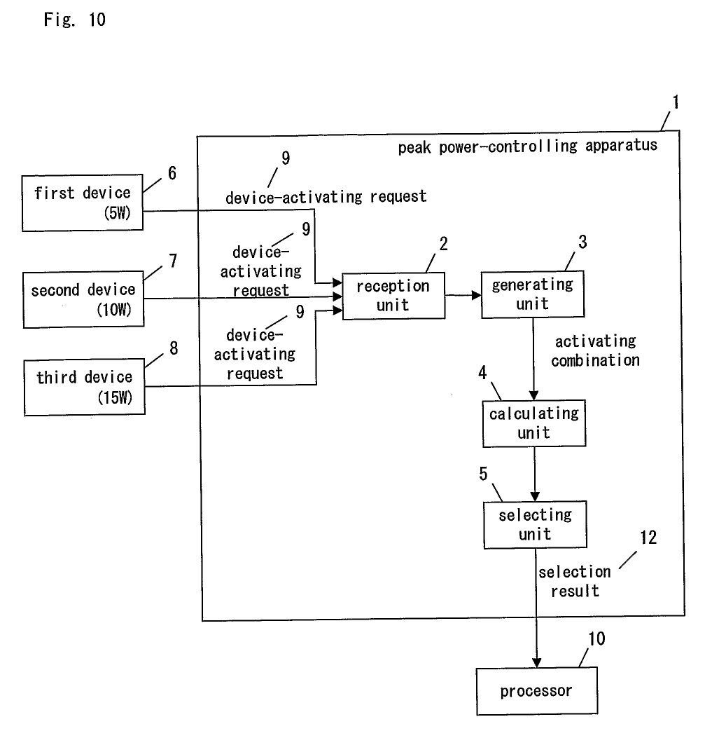

The following discusses, with reference to FIG. 10, a configuration operable to generate the activating combinations in response to a device-activating request addressed by each of the devices.

FIG. 10 is a block diagram illustrating the peak power-controlling apparatus according to the present embodiment. FIG. 10 illustrates a pattern in which a plurality of devices (the first, second, and third devices 6, 7, and 8) self-feed respective device-activating requests 9 into the peak power-controlling apparatus 1, and the selection result 12 is thereafter sent out to the processor 10 from the selecting unit 5, whereby the devices are activated by the processor 10.

There is available an alternative pattern in which a master device addresses a device-activating request into the peak power-controlling apparatus 1 in order to activate a slave device, and the master device is authorized by the peak power-controlling apparatus 1 to activate the slave device.

The peak power-controlling apparatus 1 includes a reception unit 2. The reception unit 2 is operable to receive the device-activating requests 9 from the plurality of devices, and to feed results from the reception into the generating unit 3. The generating unit 3 generates activating combinations based on only the devices that have addressed the device-activating requests 9 among all of the devices controlled by the peak power-controlling apparatus 1.

More specifically, the generating unit 3 generates the activating combinations for only the devices that have addressed the device-activating requests 9, among the three different devices or rather the first device 6, second device 7, and third device 8. When only two different devices, e.g., the first and third devices 6 and 8 address the device-activating requests, the generating unit 3 generates three different combinations, i.e., one for activating only the first device 6, another for activating only the third device 8, and the rest for activating only a set of the first and third devices 6 and 8. Subsequent processing after the generation of the activating combinations is made as described with reference to FIG. 9.

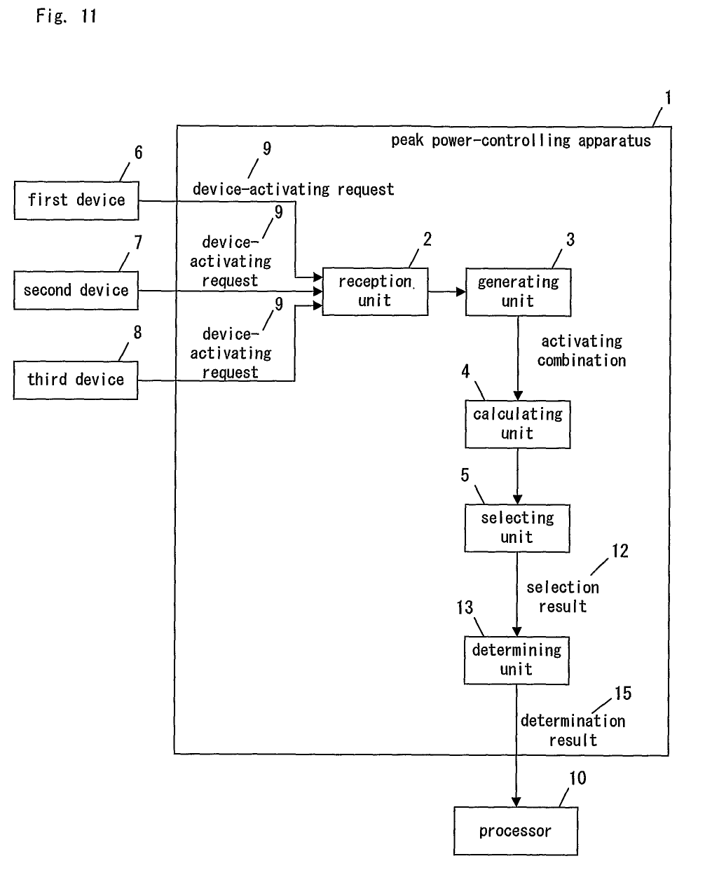

The following discusses, with reference to FIG. 11, a process in which the selecting unit 5 selects the selection result 12 that includes a plurality of activating combinations.

FIG. 11 is a block diagram illustrating the peak power-controlling apparatus according to the present embodiment. The reception unit 2 may optionally be provided. FIG. 11 illustrates a pattern in which a plurality of devices (the first, second, and third devices 6, 7, and 8) are activated by the processor 10 after they self-address the device-activating requests 9. There is available an alternative pattern in which a master device addresses a device-activating request into the peak power-controlling apparatus 1 in order to activate a slave device, and the master device is thereafter authorized by the peak power-controlling apparatus 1 to activate the slave device.

The selecting unit 5 generates the selection result 12 that includes a plurality of activating combinations, and then feeds the generated selection result 12 into a determining unit 13. The determining unit 13 determines, as a determination result 15, one of the plurality of activating combinations from the selection result 12. This means that the two-staged processing ultimately determines an activating combination for use in activating the devices in practice.

For example, the selecting unit 5 selects the activating combinations based on the permissible power value. The determining unit 13 determines one of the selected activating combinations based on another reference such as device-activating priority or otherwise the number of the devices to be activated.

The determination result 15 that includes the ultimately determined activating combination is sent out of the determining unit 13 to the processor 10. The processor 10 activates the devices in accordance with the content of the determination result 15. Alternatively, the determination result 15 is sent out directly to the devices without passing through the processor 10, and then the devices are activated in accordance with the content of the determination result 15.

The following discusses, with reference to several processing patterns, the way in which the selecting unit 5 and the determining unit 13 make a selection and a determination, respectively.

An initial description is now made to a first processing pattern.

According to the first processing pattern, the selecting unit 5 selects, as the selection result 12, a plurality of activating combinations that possess total power consumption equal to or smaller than the permissible power value. Subsequently, the determining unit 13 determines, as the determination result 15, an activating combination having a minimum total power consumption value from among the plurality of activating combinations included in the selection result 12.

For example, when the permissible power value is 15 W, then four different activating combinations or Activating Combinations No. 1 to No. 4 are selected as the selection result 12, among which Activating Combination No. 1 has the total power consumption value of 5 W or the minimum total power consumption value. As a result, the determining unit 13 determines Activating Combination No. 1 as the determination result 15 from among the four different combinations.

The ultimate use of the activating combination having the minimum total power consumption value suppresses the power consumption value to a minimum extent.

The following discusses a second processing pattern.

According to the second processing pattern, the selecting unit 5 selects, as the selection result 12, a plurality of activating combinations that possess total power consumption equal to or smaller than the permissible power value. Subsequently, the determining unit 13 determines, as the determination result 15, an activating combination having a maximum total power consumption value from among the plurality of activating combinations included in the selection result 12.

For example, when the permissible power value is 20 W, then Activating Combinations No. 1 to No. 5 are selected as the selection result 12, among which Activating Combination No. 5 has the total power consumption value 20 W or the maximum total power consumption value. Consequently, the determining unit 13 determines Activating Combination No. 5 as the determination result 15.

When the permissible power value is 10 W, then Activating Combination No. 2 is determined as the determination result 15.

The aforesaid processing activates the devices through the efficient consumption of electrical power in a range equal to or smaller than the permissible power value.

When the permissible power value is 15 W, then Activating Combinations No. 3 and No. 4 are two different activating combinations having maximum total power consumption values equal to or smaller than 15 W. In this event, as discussed later, a selection is made to activating combinations that activate a large number or otherwise a small number of devices.

Alternatively, activating combinations that include less frequently activated devices may be selected. As a further alternative, activating combinations different from the determination result 15 determined by immediately previous processing may be selected.

The following discusses a third processing pattern.

According to the third processing pattern, the selecting unit 5 selects, as the selection result 12, a plurality of activating combinations that possess total power consumption equal to or smaller than the permissible power value. Subsequently, the determining unit 13 determines, as the determination result 15, an activating combination having the greatest number of devices to be activated, on the basis of the selection result 12.

For example, when the permissible power value is 15 W, then Activating Combinations No. 1, No. 2, No. 3, and No. 4 are selected as the selection result 12.

Activating Combination No. 4 among the four different combinations includes two different devices to be activated, i.e., the first and second devices 6 and 7. This means that Activating Combination No. 4 has the greatest number of devices to be activated. Accordingly, the determining unit 3 determines Activating Combination No. 4 as the termination result 15.

When the permissible power value is 30 W, then Activating Combination No. 7 includes three different devices to be activated, and is consequently determined as the determination result 15.

The following discusses a process of determining the determination result 15 on the basis of device-activating priority.

Each of the devices has priority to be activated. The priority is represented by, e.g., numeral values. Assume that the first, second, and third devices 6, 7, and 8 are provided with the priorities expressed by values “1”, “2”, and “3”, respectively. Table 3 illustrates a total score of the priority for each of a plurality of activating combinations.

TABLE 3

| | | total power | total |
|---|---|---|---|
| | activating combination | consumption | value |
| 1 | first device | 5 W | 1 |
| 2 | second device | 10 W | 2 |
| 3 | third device | 15 W | 3 |
| 4 | first device + second device | 15 W | 3 |
| 5 | first device + third device | 20 W | 4 |
| 6 | second device + third device | 25 W | 5 |
| 7 | first device + second device + third device | 30 W | 6 |

When the permissible power value is 20 W, then Activating Combinations No. 1 to No. 5 are selected as the selection result 12, among which Activating Combination No. 5 has priority expressed by a total score having the value “4” or a maximum value. Accordingly, the determining unit 13 determines Activating Combination No. 5 as the determination result 15.

This is priority-based processing, whereby the devices are activated both within the permissible power value and based on the device-activating priority.

If a plurality of activating combinations remain to be selected, as a result of the determination based on the number of the devices to be activated or otherwise based on the device-activating priority, any one of the remaining activating combinations may be determined as the determination result, or alternatively, another determination may be made based on another reference such as, e.g., the total power consumption value.

The determining unit 13 is optionally allowed to determine the determination result 15 based on a further reference combined with the device-activating priority, the number of devices to be activated, and the total power consumption value.

The above-described selection and determination may be made either only once during several predetermined periods of time or for each predetermined period of time.

Although the present embodiment exemplifies the three different devices, more than or less than three devices may be activated similarly.

The peak power-controlling apparatus 1 as described above may be made by either hardware or software, or otherwise by both of the hardware and the software.

The peak power-controlling apparatus is not limited to an apparatus, but may include a course of processing as described by the present embodiment.

A peak power-controlling method includes a receiving step comparable to the reception unit 2, a generating step comparable to the generating unit 3, a calculating step comparable to the calculating unit 4, a selecting step comparable to the selecting unit 5, and a determining step comparable to the determining unit 13.

The receiving step includes receiving device-activating requests addressed by a plurality of devices. The generating step includes generating at least one combination available within a predetermined period of time to activate each device having an activating period (which includes operative and inoperative periods of time) and required power consumption. The calculating step includes calculating a total power consumption value for each of the activating combinations. The selecting step includes selecting either a single activating combination or a plurality of activating combinations from among the at least one activating combination. At this time, the selecting step includes selecting the activating combinations based on a comparison between the total power consumption value and the permissible power value. The determining step includes determining, as a determination result, one of the selected plurality of activating combinations on the basis of the device-activating priority or the number of the devices to be activated.

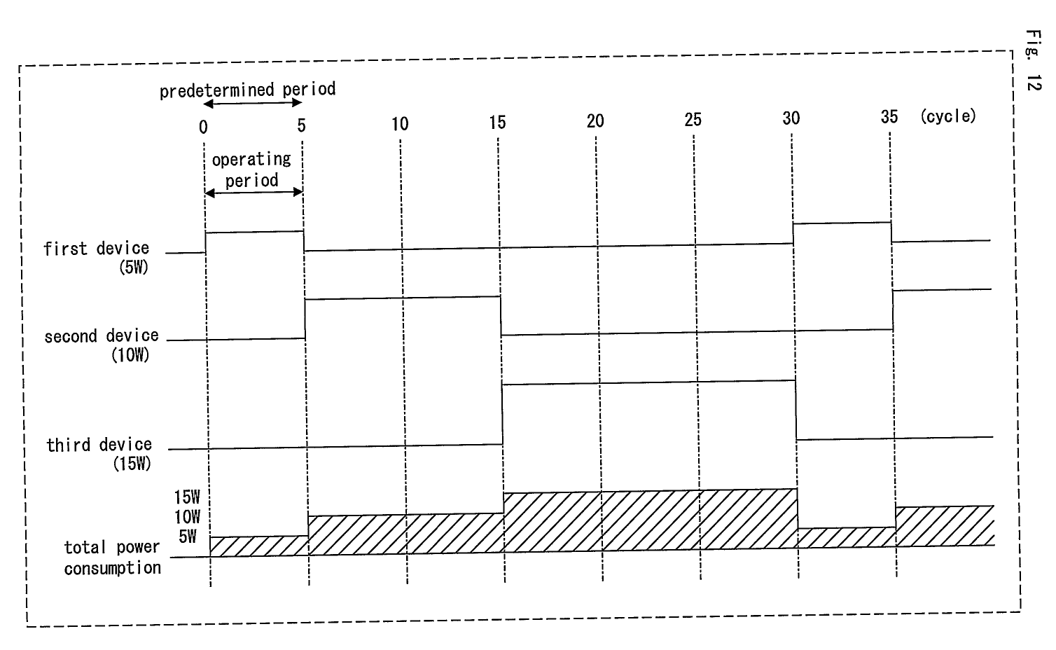

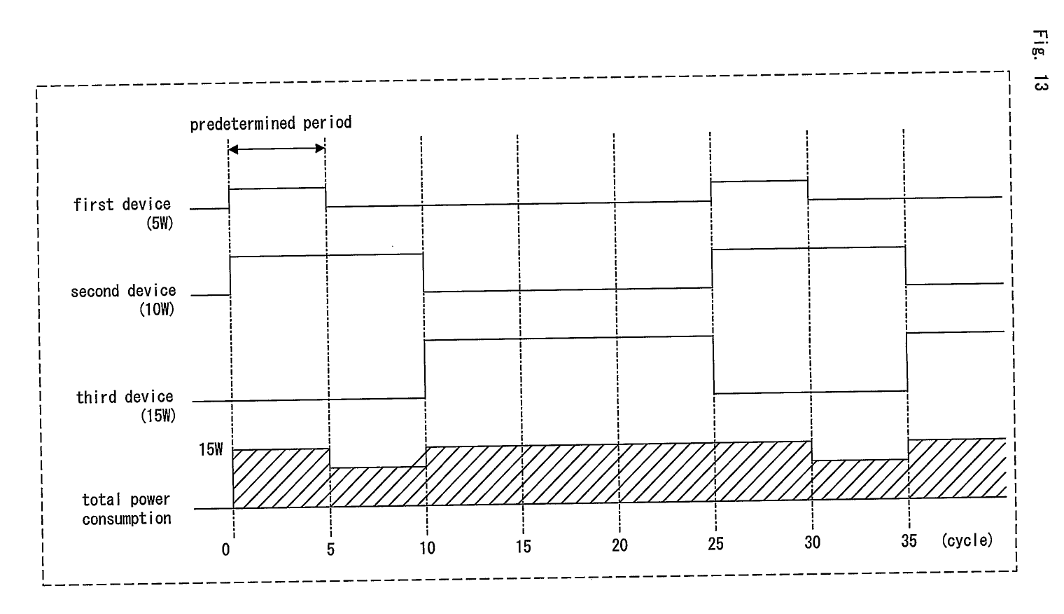

The following discusses, with reference to FIGS. 12 and 13, a course of operation, as seen along a temporal axis, provided by each of the devices to be activated.

FIGS. 12 and 13 are different time charts illustrating each pattern in which the devices are activated according to the present embodiment.

FIG. 12 illustrates a pattern in which each of the devices is determined to be activated during a predetermined period of time. At initial one of the predetermined periods of time, a determination is made as to a pattern in which each of the devices is activated, and as to an activating period (operative and inoperative periods of time) of each of the devices. After the determination, each of the devices is operated in accordance with the determined activating period. FIGS. 12 and 13 are premised on the permissible power value of 15 W.

In FIG. 12, an activating combination is determined on the premise of the permissible power value 15 W to avoid overlapping operative periods of time for the plurality of devices with each other. As a result, at an initial predetermined period of time between 0 and 5 cycles, only the first device 6 is operated at the total power consumption value of 5 W. At the following period of time, the second device 7 is determined to be activated, and only the second device 7 is operated during 10-cycle period between 5 and 15 cycles at the total power consumption value of 10 W.

Subsequently, the third device 8 is determined to be activated, and only the device 8 is operated during a period of time between 15 and 30 cycles at the total power consumption value of 15 W.

The determined activating combination provides the first device 6 having an activating period that includes 5 cycles as an operative period of time and 25 cycles as an inoperative period of time; the second device 7 having an activating period that includes 10 cycles as an operative period of time and 15 cycles as an inoperative period of time; and the third device 8 having an activating period that includes 15 cycles as an operative period of time and 15 cycles as an inoperative period of time. As a result, the plurality of devices are prevented from having respective operative periods of time overlapped with each other, and the devices are activated within the permissible power value.

However, there are cases where the activating combination cannot be determined, depending upon a value of an activating period for each of a plurality of devices, although each of the plurality of devices is prevented from having a course of operation overlapped with that of another device. In short, there are cases where no activating combination is determinable when the plurality of devices must be operated at the same period of time. In particular, if a device having an unchangeable activating period is included in the plurality of devices, the plurality of devices must be concurrently activated within the permissible power value.

FIG. 13 illustrates a pattern in which a plurality of devices are activated at the same period of time.

Referring to FIG. 13, the third device 8 is shown having only 10 cycles as an inoperative period of time, which is less than a total of 15 cycles of 5 cycles as an operative period of time possessed by the first device 6, plus 10 cycles as an operative period of time possessed by the second device 7, when the first and second devices 6 and 7 are operated serially with each other along the temporal axis. As a result, both of the first device 6 and the second device 7 are operated during the 10-cycle inoperative period of time possessed by the third device 8. The concurrent operation of both of the third device and the other devices is prohibited in light of the permissible power value.

To solve the inconvenience, as illustrated in FIG. 13, the first and second devices 6 and 7 are activated, and then the third device 8 is activated when the second device 7 having the 10-cycle operative period of time ceases its operation. More specifically, at respective periods of time between 0 and 5 cycles, between 5 and 10 cycles, and between 10 and 25 cycles, the devices are operated in accordance with Table 1, Activating Combinations No. 4, No. 2, and No. 3, respectively. Such a pattern of activating combinations is subsequently repeated.

The activating combinations are thus determined at three different predetermined periods of time, i.e., one between 0 and 5 cycles, another between 5 and 10 cycles, and the rest between 10 and 25 cycles. Subsequent activating combinations need be neither selected nor determined.

As evidenced by FIG. 13, the total power consumption value is at most 15 W. When the permissible power value is 15 W, then the first, second, and third devices 6, 7, and 8 are activated without allowing the total power consumption value to exceed the permissible power value.

As described above, either the peak power-controlling apparatus according to the present embodiment or the peak power-controlling method according thereto activates a plurality of devices within the permissible power value.

In addition, either the peak power-controlling apparatus according to the present embodiment or the peak power-controlling method according thereto allows the plurality of devices to be activated at the same period of time while the total power consumption value remains within the permissible power value. Furthermore, either the peak power-controlling apparatus according to the present embodiment or the peak power-controlling method according thereto activates the plurality of devices within the permissible power value, even when a device having an unchangeable activating period is included in the plurality of devices.

Moreover, either the peak power-controlling apparatus according to the present embodiment or the peak power-controlling method according thereto provides the two-staged processing achieved by both of the selecting unit 5 operable to select the activating combinations based on the permissible power value, and the determining unit 13 operable to determine the ultimately available activating combination based on, e.g., the device-activating priority. As a result, the high-performance activation of the devices is achievable.

The present invention activates the devices to be periodically activated, in such adjusted timing with each other as to allow the total power consumption value reached by the aforesaid devices in operation to lie within a predetermined value, whereby the peak power-controlling apparatus including the periodically activated devices provides suppressed peak power consumption.

In addition, the present invention activates the plurality of devices in light of the power consumption value or otherwise, e.g., the device-activating priority.

Furthermore, the present invention provides the two-staged processing including the steps of selecting the activating combinations based on the power consumption value, and determining one of the selected activating combinations based on the device-activating priority or otherwise the number of the devices to be activated, whereby the high-performance activation of the devices is realized. As a result, a high-level of peak power control is provided.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

### INDUSTRIAL APPLICABILITY

The present invention finds desirable applications in the technical field in which, e.g., a cutback in electrical power must be attained.

1. A peak power-controlling apparatus comprising:
a generating unit operable to generate at least one activating combination available within a predetermined period of time to activate a plurality of devices, each of the plurality of devices having an activating period and required electrical power, the activating period including an operative period of time and an inoperative period of time;
a calculating unit operable to calculate a total power consumption value for each of the at least one activating combination, thereby providing at least one calculated total power consumption value; and
a selecting unit operable to select, as a selection result, one of the at least one activating combination based on the at least one calculated total power consumption value.

2. A peak power-controlling apparatus as defined in claim 1, wherein said selecting unit selects, as the selection result, an activating combination having a minimum value among the at least one calculated total power consumption value.

3. A peak power-controlling apparatus as defined in claim 1, wherein the predetermined period of time is substantially equal to shortest one of the operative periods of time possessed by the plurality of devices.

4. A peak power-controlling apparatus as defined in claim 1, further comprising:
a reception unit operable to receive activating requests addressed by the plurality of devices,
wherein said generating unit generates the at least one activating combination available within the predetermined period of time to activate the plurality of devices that have addressed the activating requests.

5. A peak power-controlling apparatus as defined in claim 1, further comprising:
a determining unit operable to determine, as a determination result, one of a plurality of activating combinations included in the selection result, when said selecting unit selects the plurality of activating combinations as the selection result.

6. A peak power-controlling apparatus as defined in claim 5, wherein said selecting unit compares the total power consumption value for each of the plurality of activating combinations with a predetermined permissible power value, thereby selecting, as the selection result, a plurality of activating combinations having the total power consumption values equal to or smaller than the predetermined permissible power value.

7. A peak power-controlling apparatus as defined in claim 6, wherein said determining unit determines, as the determination result, one of the plurality of activating combinations included in the selection result, thereby providing a determined activating combination, the determined activating combination having a largest number of the devices to be activated.

8. A peak power-controlling apparatus as defined in claim 6, wherein said determining unit determines, as the determination result, one of the plurality of activating combinations included in the selection result, thereby providing a determined activating combination, the determined activating combination having a maximum value among the at least one calculated total power consumption value.

9. A peak power-controlling apparatus as defined in claim 6, wherein said determining unit determines, as the determination result, one of the plurality of activating combinations included in the selection result, thereby providing a determined activating combination, the determined activating combination having any one of the devices to have been activated a smallest number of times during a predetermined period of time.

10. A peak power-controlling apparatus as defined in claim 6, wherein each of the plurality of devices has priority to be activated, and wherein said determining unit calculates a total score of the priority for each of the plurality of activating combinations included in the selection result, thereby determining, as the determination result, an activating combination having maximum one of the total scores of the priority.

11. A peak power-controlling method comprising:
generating at least one activating combination available within a predetermined period of time to activate a plurality of devices, each of the plurality of devices having an activating period and required electrical power, the activating period including an operative period of time and an inoperative period of time;
calculating a total power consumption value for each of the at least one activating combination, thereby providing at least one calculated total power consumption value; and
selecting, as a selection result, one of the at least one activating combination based on the calculated total power consumption value.

12. A peak power-controlling method as defined in claim 11, wherein said selecting, as the selection result, one of the at least one activating combination based on the at least one calculated total power consumption value comprises selecting, as the selection result, an activating combination having a minimum value among the at least one calculated total power consumption value.

13. A peak power-controlling method as defined in claim 11, further comprising:
receiving activating requests addressed by the plurality of devices,
wherein said generating the at least one activating combination available within the predetermined period of time to activate the plurality of devices comprises generating the at least one activating combination available within the predetermined period of time to activate the plurality of devices that have addressed the activating requests.

14. A peak power-controlling method as defined in claim 11, further comprising:
determining, as a determination result, one of a plurality of activating combinations included in the selection result, when said selecting, as the selection result, one of the at least one activating combination based on the at least one calculated total power consumption value comprises comparing the total power consumption value for each of the at least one activating combination with a predetermined permissible power value, to select, as the selection result, the plurality of activating combinations having the total power consumption values equal to or smaller than the predetermined permissible power value.

15. A peak power-controlling method as defined in claim 14, wherein said determining, as the determination result, one of the plurality of activating combinations included in the selection result comprises determining, as the determination result, one of the plurality of activating combinations included in the selection result, thereby providing a determined activating combination, the determined activating combination being an selection from one of: the determined activating combination having a largest number of the devices to be activated; the determined activating combination having a maximum total power consumption value; and the determined activating combination having any one of the devices to have been activated a smallest number of times during a predetermined period of time.

16. A peak power-controlling method as defined in claim 14, wherein each of said plurality of devices has priority to be activated, and wherein said determining, as the determination result, one of the plurality of activating combinations included in the selection result comprises calculating a total score of the priority for each of the plurality of activating combinations included in the selection result, thereby determining, as the determination result, an activating combination having maximum one of the total scores of the priority.
